(19) United States
(12) Patent Application Publication
(10) Pub. No.: US 2017/0275075 A1
(43) Pub. Date: Sep. 28, 2017

(54) Vacuum Sealed Container for Perishable and Non Perishable Goods

(71) Applicants: Erika Bamonte, Howell, NJ (US); April Bamonte, Howell, NJ (US)

(72) Inventors: Erika Bamonte, Howell, NJ (US); April Bamonte, Howell, NJ (US)

(21) Appl. No.: 15/428,354

(22) Filed: Feb. 9, 2017

Related U.S. Application Data
(63) Continuation of application No. 15/080,348, filed on Mar. 24, 2016.

(51) Int. Cl. B65D 81/20; B65D 25/04; A47J 47/10; B65D 25/54; B65D 21/02; B65D 43/02

(52) U.S. Cl. CPC B65D 81/2015; B65D 21/0217; B65D 43/0225; A47J 47/10; B65D 25/54; B65D 25/04

(57) ABSTRACT

An inventive vacuum storage container for long term storage of perishable and non-perishable items with secondary storage cavity inside the base. The inventive vacuum storage container incorporates a top cover with vacuum valve and bottom base with an elastic seal. Furthermore, the bottom base possesses removable bottom which couples to the bottom base to form a second interior storage cavity. The removable bottom base may also be coupled with a display surface.

### FIELD OF THE INVENTION

The present invention relates to a container and base for the purpose of creating a vacuum cavity within which to store items. The invention may be used to store various types of goods needing to be preserved within a vacuum, including both perishable and non-perishable items. The present invention further encompasses a base containing a second cavity for storing other items, such as keepsakes. Furthermore, the present invention is designed so that the upper surface may support the bottom surface of a duplicate for vertical stacking. Finally, the present invention includes a removable base bottom operable to receive a display surface for displaying items.

### BACKGROUND OF THE INVENTION

In the prior art, vacuum containers for storing perishable items exist. For example, many newlyweds save a portion or the entire top tier of their wedding cake to eat on their first anniversary for good luck. Furthermore, many individuals chose to save other items including perishable and non-perishable nature. The problem that many experience is that there is simply no suitable method currently available for the long term storage of both perishable and non-perishable items. Furthermore, displaying the items often requires a separate decorative stand.

One method of storing perishable and non-perishable goods for long periods is to simply wrap them up in a substance such as plastic wrap or aluminum foil and to place them in a freezer. This is most common for baked goods. This serves the purpose of limiting the growth of bacteria and fungi on the baked good, but leads to several problems. First, the unsealed wrap leads to freeze burn, which is caused by dehydration and oxidation due to air reaching the item, rendering the item unpalatable. Second, baked goods often contain high proportions of fatty ingredients such as butter. These fatty ingredients help to create the appealing flavor of the item, but also have a tendency to absorb other odors if exposed to them. Given that many refrigerators recycle the air between the refrigerated section and the freezer section, this can lead to the transfer of unwelcome flavors and aromas, such as those from onions and garlic, to the baked good.

Preserving food items over long periods of time has given rise to several preservation methods, ranging from canning to pickling. However, none of these methods are suitable for the long term storage of perishable items such as baked goods. The only suitable method is to create a vacuum sealed cavity within which to store the item. The creation of the vacuum occurs as air is removed from the cavity. This helps prevent the growth of bacteria and fungi, as well as preventing the evaporation of water and other volatile compounds which lend the baked goods their aroma flavor and moist texture. Furthermore, these baked goods are often stored in freezers for lengthy periods, which tends to result in the transfer of other undesirable aromas and flavors to the baked goods. By storing the baked goods inside a vacuum cavity, these problems can be solved.

Numerous forms of vacuum bags have been produced in order to overcome the problems of odor absorption and freezer burn. However, these create problems specific to the storage of baked goods. These types of items contain large volumes of air as a result of the baking process. Using a vacuum sealed bag removes the air, which is desirable, but causes the flexible container to collapse around the baked item, causing the compression of the baked good into a dense and undesirable lump.

One solution to the collapsing problem is to incorporate a rigid container. However, the rigid prior art products suffer from one of two problems arising from the fact that they come in one of only two configurations. The first configuration is a canister shape with a top containing a vacuum seal. The second configuration has a lid on the bottom, but with a dome shaped cover and a vacuum pump attached. In the first configuration there is a problem arising from having to lower a cake down into a container, potentially marring the delicate outer covering of the cake from contact with the side walls of the container. In the second configuration the problem of the bulkiness of having the vacuum pump built into the top of the container exist. There is also a problem of limited stackability ability given the dome shape of the cover.

Furthermore, in the prior art entirely different articles, such as decorative display stands, are requires for displaying the items.

While these solutions solve some of the problems associated with long term storage of baked goods, none of them provide a compact, stackable baked goods storage solution which protects against freezer burn, bacterial and fungi growth, and odor absorption, as well as adding additional storage for other keepsake items. Furthermore, the prior art is not configurable to accommodate a display surface while maintaining the storage space of the present invention.

### SUMMARY OF THE INVENTION

A vacuum sealed container comprising a base plate with removable bottom and cavity and a top surface for placing perishable goods, an elastic ring, and a top cover with vacuum valve is disclosed. When the cylindrical cover engages the base plate, a storage compartment is formed. The base plate is separable from the container and servers as a support platform for the baked good. Furthermore, the removable base bottom and base form a second internal storage compartment.

By providing a separable base and cover, baked goods may be easily placed on the base without having to be lowered into the container as in prior art containers. In the preferred embodiment, the top cover is cylindrical in shape with a flat top and hollow interior.

Furthermore, an elastic seal encircles the interior surface of the lip. The seal is sandwiched between the bottom surface of the sides of the top cover and the interior edge of the lip and upper surface of the base plate. The elastic seal helps form a barrier to stop the ingress or egress of gases, thus aiding in forming a vacuum.

The cover may be cylindrical, rectangular, or any other three-dimensional shape suitable for storing baked goods. On the top surface of the cover is a vacuum valve. The valve connects to a vacuum pump for the removal of gasses from inside of the cavity formed by the cover and base plate. Additionally, the valve may be located on the side of the cover or located on the side of the base plate.

The cover is preferably shaped to be slightly smaller in circumference or length and width so as to fit within depression similarly sized on the removable base of a second duplicate of the invention. This allows the invention to stack securely upon a duplicate.

The base plate is preferably made of BPA a free plastic, but could be made of other materials including glass, ceramic, metal, or any other ridged and non-hazardous material. The outer edge of the top surface of the plate is beveled. The base plate is sized to be slightly larger than the bottom edge of the cylindrical cover so that the base edges overhang slightly. Additionally, the base plate edge contains a lip that angles up, having a bottom edge that so that the interior edge of the base lip contacts the exterior edge of the cylindrical cover. Furthermore, the lip serves to keep the baked good from contacting the interior surfaces of the cylindrical container.

The base plate contains an interior cavity for additional storage. The cavity is formed by the hollow interior of the base plate and the removable base bottom. The removable base bottom may be secured to the base plate through a threaded fastener system, or by vacuum pressure. Additionally, a second elastic seal can be provided on the bottom edge of the base plate, or on the top surface of the removable base bottom.

The removable base plate possesses a shallow depression which is preferably shaped to be slightly larger in circumference or length and width than the cover to allow the removable base to sit securely on top of a duplicate.

The removable base plate may also be coupled with a display surface by means of an inclined plain.

### BRIEF DESCRIPTION OF THE DRAWINGS

Embodiments of the invention will now be described, by way of example, with reference to the accompanying drawings, wherein:

FIG. 1 is shows the components of the preferred embodiment of the inventive vacuum sealed pastry save with additional storage.

FIG. 2 shows an alternate embodiment.

FIG. 3 shows an expanded view of the preferred embodiment.

FIG. 4 shows an expanded view of the base plate and removable base bottom of the preferred embodiment.

FIG. 5 shows an expanded view of the base plate and removable base bottom of an alternate embodiment.

### DETAILED DESCRIPTION

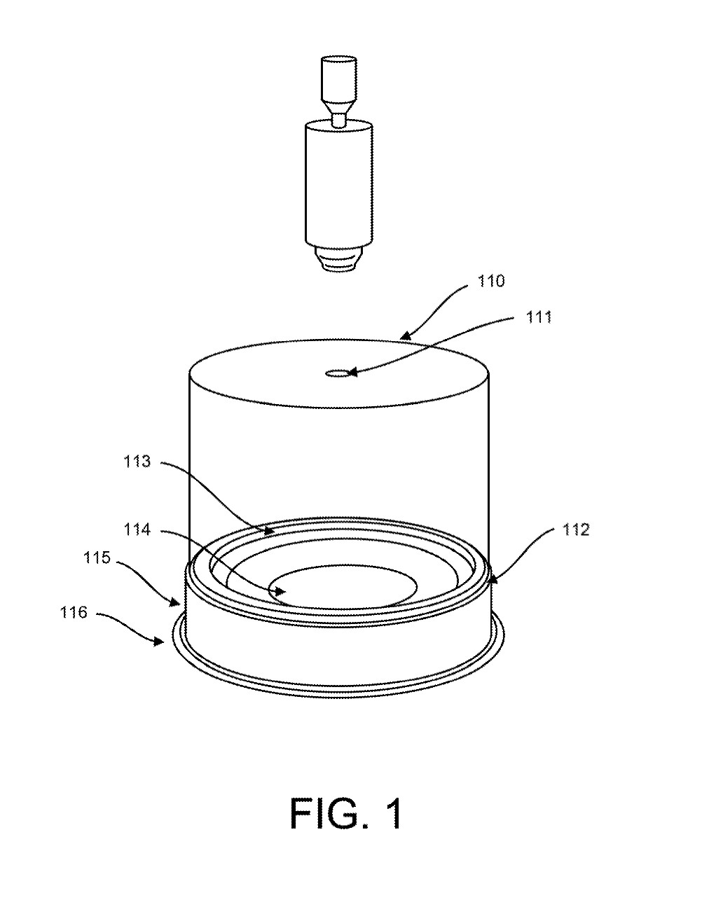

FIG. 1 shows a preferred embodiment of the invention having a cylindrical cover with a top surface and bottom edge (110) with a vacuum valve (111). The hollow interior of a cylindrical cover (110) forms an interior cavity when placed on base plate (115). Base plate (115) possesses a top surface (114) and elastic seal (113). Elastic seal (113) is designed to couple with an external vacuum pump, which can be one of many types known in the prior art, for evacuating the gases from interior cavity formed by cylindrical cover (110) and base plate (115). Top surface (114) is formed so as to sit below the level of elastic surface (113) and provide a supportive surface for placing a baked good or other perishable item to be stored. Furthermore, the top surface (114) possesses beveled edges structure to serve as a placement guide for baked goods or other perishable items to be store, which aids in keeping the item for making contact with interior surface of cylindrical cover (110). The bottom edge (112) of cylindrical cover (110) contacts elastic seal (113) so as to form impermeable barrier to the ingress and egress of gasses. Finally, base plate possess a removable base bottom (116). Base plate (115) and base bottom (116) join together to form an interior cavity (not shown in FIG. 1) for storing additional items. Removable base bottom (116) possesses a bottom surface with a depression shaped to be slightly larger in circumference that the top surface of cylindrical cover (110), allowing for securely stacking the invention on top of a duplicate.

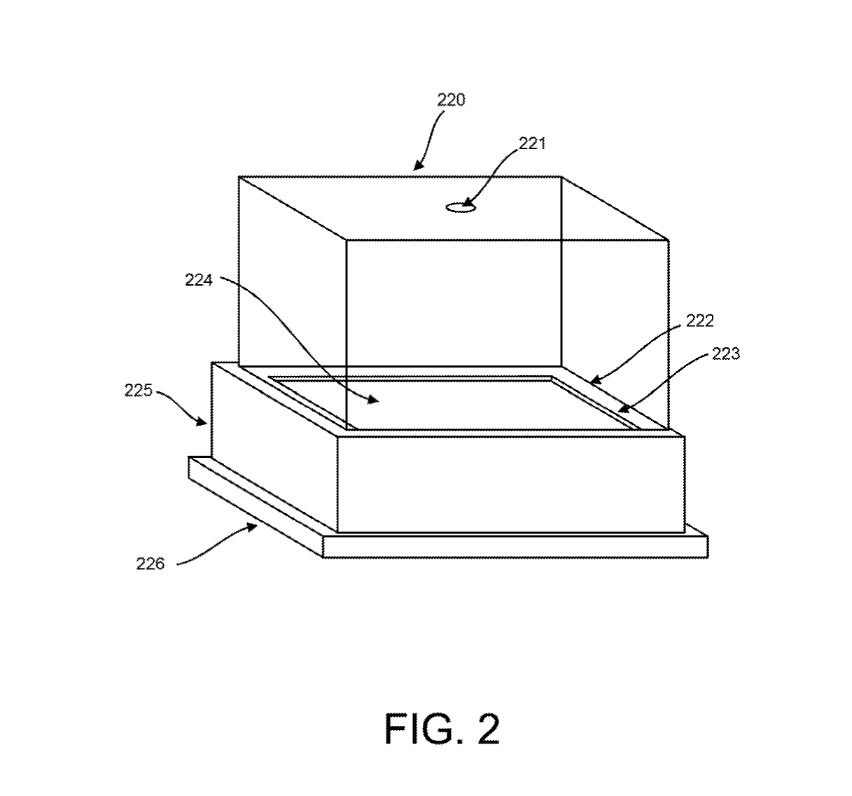

Fig. 2 shows an alternate embodiment of the present invention with a square or rectangular cover (220) having a top surface, side surfaces and bottom edge (222) with a vacuum valve (221) on top surface. The hollow interior of square cover (220) forms an interior cavity when placed on base plate (225). Base plate (225) possesses a top surface (224) and elastic seal (223). Elastic seal(223) is designed to couple with an external vacuum pump, which can be one of many types known in the prior art, for evacuating the gases from interior cavity formed by cylindrical cover (220) and base plate (225). Top surface (224) is formed so as to sit below the level of elastic surface (223) and provide a supporting surface for placing a baked good or other perishable item to be stored. Furthermore, the top surface (224) possesses beveled edges structure to serve as a placement guide for baked goods or other perishable items to be store, which aids in keeping the item for making contact with interior surface of square cover (220). The bottom edge (222) of square cover (220) contacts elastic seal (223) so as to form impermeable barrier to the ingress and egress of gasses. Finally, base plate possess a removable base bottom (226). Base plate (225) and removable base bottom (226) join together to form an interior cavity (not shown in FIG. 1) for storing additional items. Removable base bottom (216) possesses a bottom surface with a depression shaped to be slightly larger in surface area that the top surface of square cover (220), allowing for securely stacking the invention on top of a duplicate.

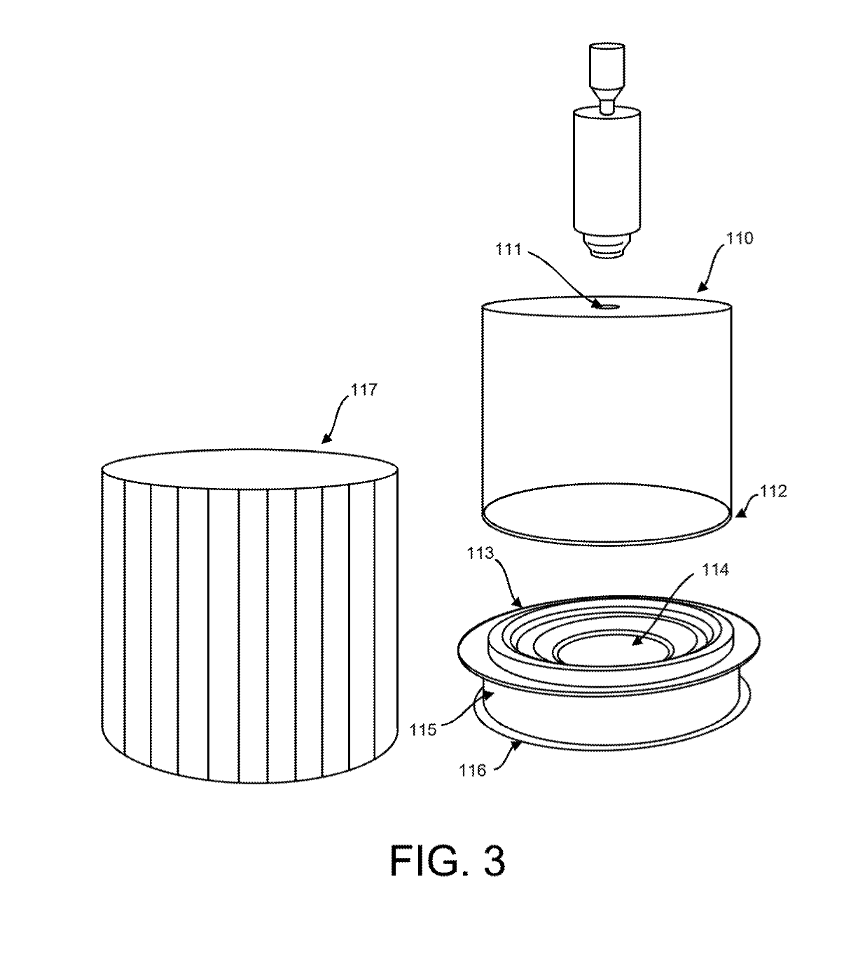

FIG. 3 shows an expended view of the preferred embodiment with cylindrical cover (10) with vacuum valve (111) and bottom edge (112), base plate (115) with elastic seal (113), top surface (114) and removable base bottom (116). Additionally, FIG. 3 includes optional decorative cover (117). Decorative cover (117) is placed over base plate (115) and cylindrical cover (10) to sit flush with bottom surface of removable base bottom (116).

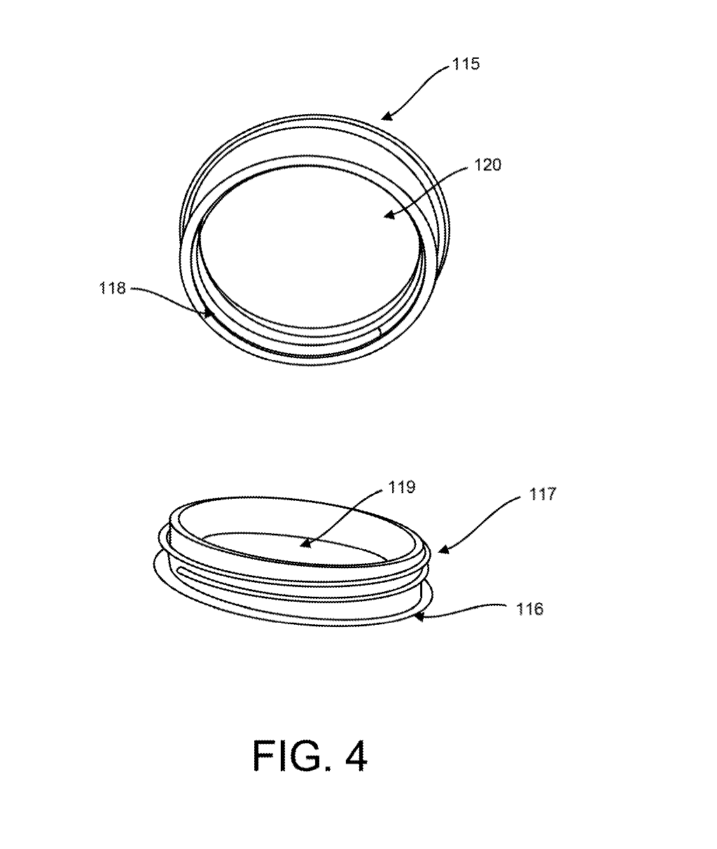

FIG. 4 shows an expanded view of the interiors of removable base bottom (116) and base plate (115). Removable base bottom (116) possesses bottom surface (119) and side surface (117). Exterior surface of side surface (117) possesses an inclined plan for coupling to inclined plain of interior surface of side surface (118) of base bottom (115). When coupled, base plate (116) and removable base bottom (116) form interior cavity (120) for providing additional storage. Exterior surface of side surface (117) may also be used to couple removable base bottom (116) with a display surface.

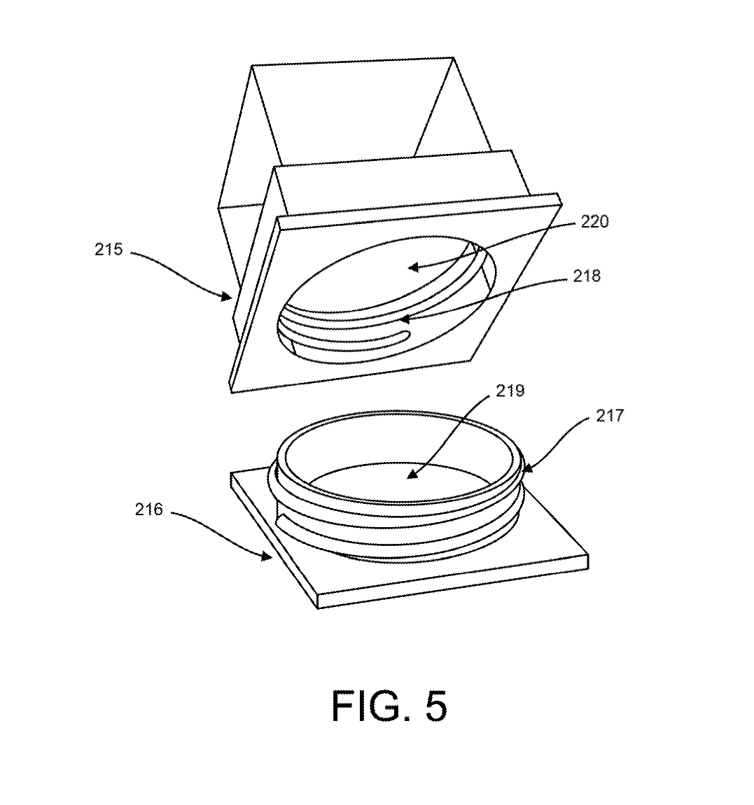

FIG. 5 shows an expanded view of the interiors of removable base bottom (216) and base plate (215). Removable base bottom (216) possesses a bottom surface (219) and side surface (217). Exterior surface of side surface (217) possesses an inclined plan for coupling to inclined plain of interior surface of side surface (218) of base bottom (215). When coupled, base plate (216) and removable base bottom (2116) form interior cavity (220) for providing additional storage. Exterior surface of side surface (217) may also be used to couple removable base bottom (216) with a display surface.

1. A vacuum storage container with incorporated secondary storage comprising:
a cylindrical cover having a vacuum valve;
a bottom base having an upper surface and side surfaces;
said bottom base having an interior cavity formed by the bottom of said upper surface and the interior surface of said side surfaces;
said side surfaces having inclined plane interior surfaces; and;
an elastic seal attached to said upper surface and shaped so as to form a seal between said bottom base and said cylindrical, cover;
wherein said vacuum valve is operable to connect to an external vacuum pump for the removal of gasses from the inside of a cavity formed by the cylindrical cover and the bottom base ; and
wherein, the cavity is operable to preserve a food item under vacuum.

2. The storage container of claim 1 wherein the bottom base narrows such that it is stackable upon the upper surface of the cylindrical cover.

3. The storage container of claim 1 wherein the bottom base contains a display compartment.

4. The storage container of claim 1 wherein the bottom base is operable to receive a display stand.
